(19) United States
(12) Patent Application Publication
(10) Pub. No.: US 2014/0291197 A1
(43) Pub. Date: Oct. 2, 2014

(54) Drug Suspension Agent and Method of Manufacture Thereof

(71) Applicant: Mengjun Yang, Beijing (CN)

(72) Inventor: Mengjun Yang, Beijing (CN)

(21) Appl. No.: 14/284,561

(22) Filed: May 22, 2014

Related U.S. Application Data
(63) Continuation of application No. 13/057,279, filed on Feb. 3, 2011.
Application No. 13/057,279 is a continuation of application No. PCT/CN2010/070330, filed on Jan. 22, 2010.

(30) Foreign Application Priority Data
Mar. 30, 2009 (CN) 200910131418.5
Nov. 11, 2009 (CN) 200910211060.7

(51) Int. Cl. A61J 1/14; A61J 3/00

(52) U.S. Cl. CPC A61J 1/1475; A61J 3/00
USPC 206/572; 53/431

(57) ABSTRACT

A drug suspension agent and method of making same is used for curing or preventing diseases, or adjusting the physiological function of a human or animal body by drug information without contacting the skin. The basic configuration of the drug suspension agent consists of a drug holder (1), a container (4) and a connector (5). The contents (2) are drugs having pharmacological activity.

### BACKGROUND OF THE PRESENT INVENTION

1. Field of Invention

The present invention relates to a drug with a new dosage form, and more particularly to a drug suspension agent and its method of manufacture.

2. Description of Related Arts

The drug is a single compound, biological product and composition directly used for human or animal to diagnose, cure and prevent human or animal diseases, purposefully adjust human or animal physiological functions, impregnate or contracept. The drug must be administered to humans or animals at a certain dosage form. This belongs to the method of administration. Traditional dosage forms of Western medicine comprise injections, pills, tablets, ointments, suppositories, and transdermal patches. Traditional dosage forms of Chinese medicine comprise ointments, dans, pills, powders, stripe formulas, lozenges, medicinal teas, and liniments. In recent years, for methods of administration, based on traditional dosage forms, a lot of controlled release preparations, which comprise the solid controlled release preparation, the transdermal controlled release preparation and so on, are invented. However, methods of administration of all existing pharmaceutical preparations, whatever the dosage form thereof is, are drug substances directly enter the human or animal body. Oral preparation drugs enter the human or animal body by oral administration via gastrointestinal digestion absorption. Injection preparation drugs enter the human or animal body by penetrating the skin with a needle into blood vessels. Transdermal preparation drugs enter the human or animal body by increasing skin permeability to make the drugs into the skin. Methods of administration of these preparations have some disadvantages. Firstly, existing pharmaceutical preparations must be added various accessories or additives, stabilizers, excipients and other non-drug ingredients. These ingredients are not necessary to cure, prevent and adjust, that is to say, a lot of accessories are wasted, and moreover, these useless materials entering the body will bring side effects to the human or animal body. Secondly, various dosage forms of existing pharmaceutical preparations have some disadvantages. Oral preparations can not avoid the first-pass effect of the gastrointestinal tract, and moreover, many oral preparations have stimulating side effects on the gastrointestinal tract. Injection punctures the skin with a needle, so that it has the risk of cross infection besides skin pain, and moreover, the impurities hard to clean up in the injection easily result in inject adverse reactions besides the drugs. For transdermal preparations, drugs and transdermal additives on the skin stimulate the skin, and simultaneously, repeated affixing of the paste material is harmful to the skin. Thirdly, existing preparations let drugs into the human or animal body, and the drugs will be biologically metabolized or excreted. Administration times are more, trouble are more, harms from preparations are more, moreover, drug consumptions are very large, drug substances can not repeatedly used, thus seriously wasting drugs. Fourthly, existing preparations let drugs into the human or animal body, so toxic side effects of the drugs themselves can not be avoided.

### SUMMARY OF THE PRESENT INVENTION

To fully solve the insufficiencies of existing dosage forms of drugs, the key is to create a new dosage form of drugs which can effectively cure, prevent human and animal diseases or adjust physiological functions thereof without absorbing drugs into the human body or animal body. The present invention successfully solves this important problem.

The drug suspension agent of the present invention is a new dosage form of drugs and product thereof, which is hung or fastened at a non-contact hanging state which is 0.1-30 cm away from the surface skin of human or animal body to effectively cure, prevent human and animal diseases, or adjust physiological functions of humans and animals by drug information superconducting, instead of oral administration, injection, transdermal or mucosal spraying, taking a drip and other methods which are capable of absorbing drugs into human body or animal body. No drug materials are consumed.

The drug suspension agent of the present invention is completely different from existing oral drug products which comprise tablets, capsules, granules, instant herbal medicines, stripe formulas, lozenges, syrups, wine agents, medicinal broths, ointments, pills and powders. It is not absorbed through the digestive tract.

The drug suspension agent of the present invention is completely different from existing injection products which comprise big and small water injection, powder injection and needle-free injection. It is not be injected into the skin or blood vessel.

The drug suspension agent of the present invention is completely different from existing transdermal patches, tincture agents, plaster agents, and sticking agents. In the drug suspension agent of the present invention, drugs will not contact the skin, and drugs will not be absorbed via the skin.

The drug suspension agent of the present invention is completely different from existing aerosols, sprays, nasal drops, nasal sprays, nasal suction agents, eye drops, eye lotions, oral gargle, pellicles, rectal enemas, and anus suppositories. In the drug suspension agent of the present invention, drugs will not contact and stimulate the mucous membrane, and drugs will not be absorbed via the mucous membrane.

The principle of the present invention solving the important problem is that it is found that human body and animal body have a new receptor, that is to say, human body and animal body have an information receptor besides a known material receptor. Traditional pharmaceutical products are absorbed into the human body through drug substances, and integrated with the material receptor, thus generating pharmacological activity effects. The drug suspension agent of the present invention produces pharmacological activity effects by integrating drug information with human body information receptor, instead of absorbing drug substances into the human body, thus producing a new medical product.

The technical solution of the present invention is shown as below.

The present invention is a drug suspension agent which is hung in the air and 0.1-30 cm away from the surface skin of the human or animal body. It is made up of a drug holder (1), a container (4) and a connector (5). The drug holder (1) is provided within the container (4), and the connector (5) is connected with the container (4). The drug holder (1) consists of a microporous carrier material layer (3) and contents (2) encased within the microporous carrier material layer (3). The contents (2) are drugs having pharmacological activities. A plurality of pores (6) are provided on a surface of the container (4) facing to the human body.

A method for manufacturing a drug suspension agent of the present invention comprises the steps of: \textcircled{1} synergizing by taking a drug, two drugs or more than two drugs; \textcircled{2} adding supplementary materials into the synergized drug with a weight of 1-10% drug weight; \textcircled{3} mechanically mixing the added synergized drug under normal pressure in a mixing machine to obtain a contents (2), wherein a mixing temperature is 15-25° C., and a mixing time is 30-60 min; \textcircled{4} making a plurality of drug holders (1) comprising the steps of packing dividually the mixed contents (2) with a microporous carrier material layer (3) into a plurality of packets in a powder filling machine, wherein a weight of every packet is determined by 1-500 times larger than clinical maximum daily dosage doses approved by pharmacopoeia or a national standard based on packed drug varieties, preferably, 50-100 times, and sealing the microporous carrier material layer (3) through hot melt technology; \textcircled{5} putting the packed drug holders (1) into a container (4); and \textcircled{6} installing a connector (5) to the container (4), thus obtaining the drug suspension agent.

While using, the drug suspension agent of the present invention is hung or fastened at the body surface of chest, upper abdomen, navel, lower abdomen, head and face, back and other parts of the human or animal body.

The drug suspension agent of the present invention can be used repeatedly, and the longest period of validity can be 3 years.

The practical value of the present invention lies in its application effects. The present invention uses standard drugs approved by the state pharmacopoeia or nation as the raw material, no drug substance enters the human or animal body while using the special dosage form of the present invention, and no safety problem appears. Therefore, in order to verify accident results of the present invention, on the one hand, the partial pharmacodynamics animal experiments are made in the present invention, on the other hand, various drug suspension agents are clinically tried by volunteers in the present invention.

Data of pharmacodynamics animal experiments of the present invention:

1. Pharmacodynamic Test of the Analgesic Effect

Kunming mice are fasted for 8 hours. Filtered animals with the basic pain threshold of 10±2 sec are divided into 7 groups, each group comprises 10 mice, in half respectively male and female. Each group is provided as below.

The blank control group uses the blank hanging box.

Tramadol suspension agent group uses the Tramadol hydrochloride hanging box which is hung below the top within the rat trap and 1-3 cm perpendicularly away from the rice at the bottom of the rat trap. Following drug suspension agents using rice as pharmacodynamic animal experiments adopt this kind of suspension mode.

Experimental Method:

Test pain thresholds at 10, 20, 30, 60, 120, 180 and 240 minutes after using, respectively.

Data processing:the increase rate of pain threshold=[(the administered TFL−the basic TFL)/the basic TFL]×100%

Results: For Tramadol suspension agent group, the increase rates of pain threshold are obviously improved at 30 min and 60 min after administering, respectively (P<0.05, P<0.01VS the blank control group).

| Classification | AUC (%. min) | Emax (%) |
|---|---|---|
| The Blank Control Group | 228.34 ± 1130.64 | 18.03 ± 10.15 |
| Tramadol Suspension Agent Group | 4365.56 ± 1709.5 | 42.45 ± 16.57 |

2. Pharmacodynamic Test of the Cough-Relieving Effect

60 kunming mice, in half respectively male and female and weighing from 18 g to 20 g, are randomly divided into 5 groups based on the weight, each group comprises 12 rice. Codeine phosphate suspension agent is hung in the test group. Codeine phosphate with a dosage of 4 mg/kg is administered to the control group by gavage.

For the above two groups, at 1 hour after administering, absorb 0.2 ml ammonia (with a concentration of 25%-28%) by 1 ml injector and inject the ammonia into the tampon with the same weight thereof, and then quickly put the injected tampon together with the white rice into an inverse 500 ml beaker, and then record the number of animal coughing within 3 minutes. The obvious decrease of cough frequency is regarded as the index of the antitussive effect.

Results:

| | | | | Cough |
|---|---|---|---|---|
| | | | | inhibition |
| | Dosage | The number of | Cough | Rate |
| Classification | (mg/kg) | animals | Frequency | (%) |
| The Blank Group | — | 12 | 34.3 ± 14.8 | — |
| The Control Group | 4.0 | 12 | 11.2 ± 4.8** | 67.3 |
| The Test Group | — | 12 | 13.1 ± 7.7** | 61.8 |

**P < 0.01, compared with the blank group

3. Pharmacodynamic Test of the Experimental Prostatic Hyperplasia

60 kunming male mice, weighing from 22 g to 26 g, are randomly divided into 6 groups. Except the blank control group, the mice of other groups are subcutaneously injected 5 mg/kg testosterone propionate, once every day. Select the prostatic hyperplasia model. After these groups are continuously treated by Finasteride suspension agent for 3 months, respectively, kill mice to weigh prostate and key testis thereof and count the index. By statistically processing, the prostate of the model group and that of the blank control group have significant differences (P<0.01), and the prostate of the suspension agent group and that of the model group have significant differences (P<0.01).

4. Pharmacodynamic Test of Hyperuricemia

Kunming male mice, weighing 24±2 g, are randomly divided into several groups, use i, g, once every day for 4 days, wherein the dosages administered to the saline group and the hyperuricemia model blank group are 100 ml/kg every day. IP potassium oxide hydrochloride for every hyperuricemia model blank group at 2 hours before blood sampling, and IP potassium oxide hydrochloride for test model group at 1 hour before the last using. At 2 hours after the last using, sample blood from the venous plexus behind the animal orbit to test the serum uric acid level.

Effects of dropping uric acid suspension agent group on the uric acid level of hyperuricemia mice are shown in Table 1. Under the experimental conditions, the dropping uric acid suspension agent will significantly reduce the serum uric acid level of hyperuricemia mice. However, the allopurinol group can reduce the serum uric acid level of normal mice.

Effect of Every Group on the Serum Uric Acid Level of Hyperuricemia Mice (X±S)

| | | Serum uric acid level |
|---|---|---|
| Classification | Dosage | of mice (mg/100 ml) |
| Saline group | — | 8.87 ± 0.17 |
| Model blank group | — | 12.68 ± 0.28 |
| Dropping uric acid suspension agent | — | 9.12 ± 0.15** |
| Allopurinol group | 10 | 7.46 ± 0.17** |

Compared with the model blank group, *P<0.05, **P<0.01

5. Antitumor Activity Test

Test Method:

Cell line A-549 human lung caner

Selecting Method: Sulforhodamine B, SRB Protein Dyeing Method

Effect time: 72 hours

Cell line MCF-7 human breast cancer

Selecting Method: The Same as the One Above

Effect time: 72 hours

Cell line BEL-7402 human liver cancer

Selecting Method: The Same as the One Above

Effect time: 72 hours

Cell line P388 mice leukemia

Selecting Method: Microcultoretetrozolium (MTT) Reduction Method

Effect time: 48 hours

Results:

| | Growth inhibition rate of the antitumor |
|---|---|
| Cell line | suspension agent to the tumor cell (%) |
| A-549 human lung cancer | 88.6 |
| MCF-7 human breast cancer | 81.3 |
| BEL-7402 human liver cancer | 79.4 |
| P388 mice leukemia | 82.7 |

Effects Data of Clinical Trial of the Present Invention:

Chronic bronchitis suspension agent made by the present invention is used to clinically treat 30 cases of chronic bronchitis, wherein 12 cases are marked, 15 cases are effective, and 3 cases are invalid.

Bronchial asthma suspension agent made by the present invention is used to clinically treat 30 cases of bronchial asthma, wherein 13 cases are marked, 15 cases are effective, and 2 cases are invalid.

Pneumonia suspension agent made by the present invention is used to clinically treat 20 cases of pneumonia, wherein 8 cases are marked, 10 cases are effective, and 2 cases are invalid.

Rheumatic fever suspension agent made by the present invention is used to clinically treat 10 cases of rheumatic fever, wherein 4 cases are marked, 5 cases are effective, and 1 case is invalid.

Coronary heart disease suspension agent made by the present invention is used to clinically treat 30 cases of coronary heart disease, wherein 15 cases are marked, 13 cases are effective, and 2 cases are invalid.

High blood pressure suspension agent made by the present invention is used to clinically treat 30 cases of high blood pressure, wherein 10 cases are marked, 17 cases are effective, and 3 cases are invalid.

Chronic gastritis suspension agent made by the present invention is used to clinically treat 10 cases of chronic gastritis, wherein 5 cases are marked, 4 cases are effective, and 1 case is invalid.

Chronic cholecystitis suspension agent made by the present invention is used to clinically treat 20 cases of chronic cholecystitis, wherein 10 cases are marked, 7 cases are effective, and 3 cases are invalid.

Colitis suspension agent made by the present invention is used to clinically treat 20 cases of ulcerative colitis, wherein 6 cases are marked, 10 cases are effective, and 4 cases are invalid.

Chronic glomerulonephritis suspension agent made by the present invention is used to treat 10 cases of chronic glomerulonephritis, wherein 3 cases are marked, 5 cases are effective, and 2 cases are invalid.

Urinary infection suspension agent made by the present invention is used to treat 30 cases of urinary infection, wherein 15 cases are marked, 12 cases are effective, and 3 cases are invalid.

Chronic myeloid leukemia suspension agent made by the present invention is used to treat 5 cases of chronic myeloid leukemia, wherein 1 case is marked, 2 cases are effective, and 2 cases are invalid.

Leukopenia suspension agent made by the present invention is used to treat 16 cases of leukemia, wherein 6 cases are marked, 7 cases are effective, and 3 cases are invalid.

Hyperthyroidism suspension agent made by the present invention is used to treat 12 cases of hyperthyroidism, wherein 5 cases are marked, 6 cases are effective, and 1 case is invalid.

Gout suspension agent made by the present invention is used to clinically treat 20 cases of gout, wherein 8 cases are marked, 12 cases are effective.

Hyperlipidemia suspension agent made by the present invention is used to treat 20 cases of hyperlipidemia, wherein 16 cases are effective, and 4 cases are invalid.

Rheumatoid arthritis suspension agent made by the present invention is used to treat 30 cases of rheumatoid arthritis, wherein 15 cases are marked, 13 cases are effective, and 2 cases are invalid.

Headache suspension agent made by the present invention is used to treat 10 cases of headache, wherein 5 cases are marked, and 5 cases are effective.

Sequelae of stroke suspension agent made by the present invention is used to treat 30 cases of sequelae of stroke, wherein 11 cases are marked, 12 cases are effective, and 7 cases are invalid.

Epilepsy suspension agent made by the present invention is used to treat 5 cases of epilepsy, wherein 5 cases are effective.

Parkinson's disease suspension agent made by the present invention is used to treat 10 cases of Parkinson's disease, wherein 3 cases are marked, 4 cases are effective, and 3 cases are invalid.

Infant simple obesity suspension agent made by the present invention is used to treat 10 cases of infant simple obesity, wherein 6 cases are marked, 2 cases are effective, and 2 cases are invalid.

Influenza suspension agent made by the present invention is used to treat 30 cases of influenza, wherein 17 cases are marked, 12 cases are effective, and 1 case is invalid.

Lung cancer suspension agent made by the present invention is used to clinically treat 5 cases of lung cancer, wherein 3 cases are effective, and 2 cases are invalid.

Gastric cancer suspension agent made by the present invention is used to clinically treat 8 cases of gastric cancer, wherein 5 cases are effective, and 3 cases are invalid.

Gynecological inflammation suspension agent made by the present invention is used to treat 30 cases of gynecological inflammation, wherein 11 cases are marked, 15 cases are effective, and 4 cases are invalid.

Dysmenorrhea suspension agent made by the present invention is used to treat 30 cases of dysmenorrhea, wherein 16 cases are marked, 12 cases are effective, and 2 cases are invalid.

Skin allergies suspension agent made by the present invention is used to treat 30 cases of skin allergies, wherein 11 cases are marked, 16 cases are effective, and 3 cases are invalid.

Acne vulgaris suspension agent made by the present invention is used to treat 30 cases of acne vulgaris, wherein 12 cases are marked, 14 cases are effective, and 4 cases are invalid.

Pharyngitis suspension agent made by the present invention is used to treat 30 cases of pharyngitis, wherein 15 cases are marked, 12 cases are effective, and 3 cases are invalid.

The present invention discloses a new dosage form of drugs and has very remarkable progressive significances.

1. In the present invention, there is no need of a great deal of supplementary materials or additives, stabilizers, excipients and other non-drug ingredients which are necessarily added to existing pharmaceutical preparations, thus avoiding adverse effects caused by the drugs entering the human body or animal body, simultaneously, saving a lot of auxiliary materials, and reducing the cost of pharmaceutical preparations.

2. No damage and shortage caused by direct administration of existing pharmaceutical preparations to the human body and animal body exist. These damages and shortages include the gastrointestinal stimulation and the gastrointestinal first-pass effect caused by oral preparations, injection pain and cross infection risk and injection transfusion reactions, the skin injure from stimulation of transdermal patches, and skin lesions from paste glue.

3. The present invention can reduce or avoid the toxic side effects of drug themselves whose pharmaceutical substances enter the human body or animal body.

4. The present invention can be repeatedly used. No pharmaceutical substance directly enters the human body or animal body to metabolize, thus greatly reducing the consumption of drugs, saving medical resources, reducing environmental pollution caused by the pharmaceutical industry, and facilitating environmental protection.

5. The present invention is simple, convenient, safe, reliable, and facilitates accepting. Especially for the old, infirm, children, patients with disturbance of consciousness, mental retardation, behavioral problems and animals treatment, the present invention is good to be applied.

6. The present invention can reduce nursing labor intensity and save labor resources.

### BRIEF DESCRIPTION OF THE DRAWINGS

FIG. 1 is a schematic view of a drug holder and a microporous carrier material layer.

FIG. 2 is a schematic view showing the structure of the product.

FIG. 3 is a schematic view of the whole product.

In the drawings, 1: drug holder, 2: contents, 3: microporous carrier material layer, 4: container, 5: connector, 6: pore

### DETAILED DESCRIPTION OF THE PREFERRED EMBODIMENT

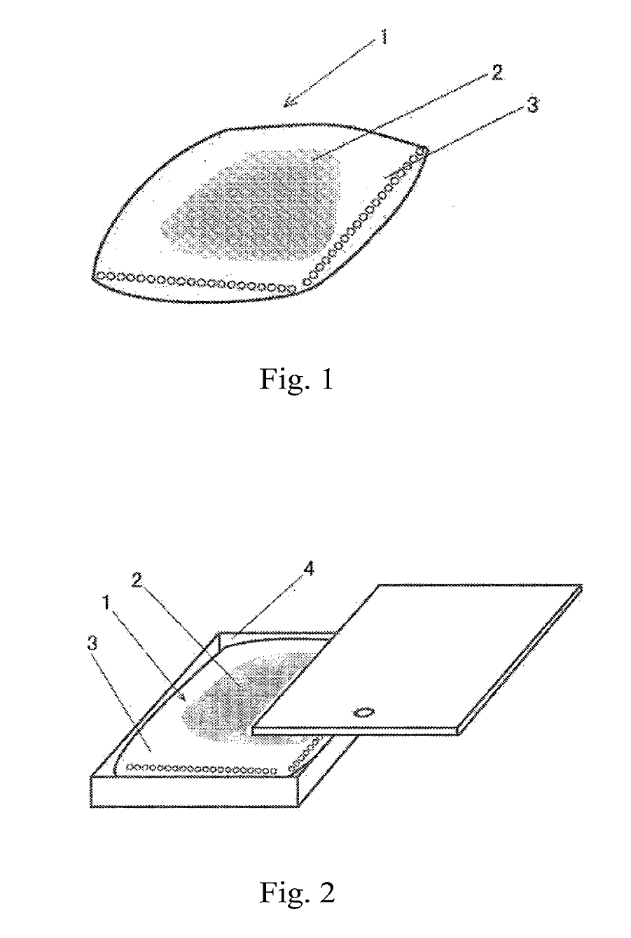

Referring to FIGS. 1 to 3 of the drawing, the present invention consists of a drug holder (1), a container (4) and a connector (5). The drug holder (1) is provided within the container (4), and the connector (5) is connected with the container (4). The drug holder (1) consists of a microporous carrier material layer (3) and a contents (2) encased within the microporous carrier material layer (3). The contents (2) are drugs having pharmacological activities and packed within the microporous carrier material layer (3) which is made of a microporous breathable material having a pore size of 50 nm-200 μm. The drug holder (1) is cased within the container (4). A plurality of pores (6) are provided on a surface of the container (4) opposite to the human body. The pores 6 can be circular, strip-shaped or others. The connector (5) is connected to the container (4). The connector (5) is a hanging object or a fixing object.

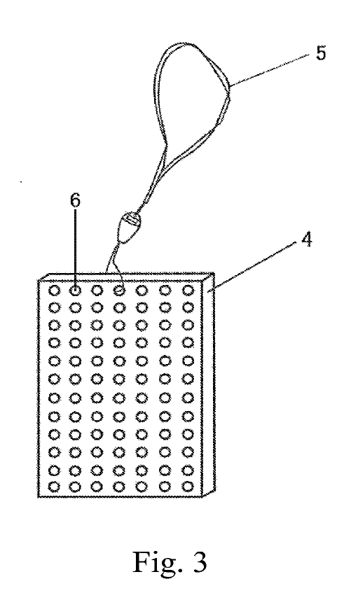

The contents (2) is a single compound, biological product and composition directly used for human or animal to cure and prevent human or animal diseases, purposefully adjust human or animal physiological functions, impregnate or contracept, and beauty-treat. The drug is approved by the national government drug administration, and accords with national pharmacopoeial standards or other national standards. It is commercially available. The microporous carrier material layer (3) is made of microporous non-woven fabrics, microporous fiber cloth, microporous paper, microporous plastic, micropore ceramic, microporous metal or microporous forming material. The container (4) is a square, rectangle, circular, flat circular, cylindrical, triangle, polygonal or irregular box body, bag body or has other forms. A rectangle box is used in FIGS. 2 and 3. A plurality of pores (6), provided on a surface of the container (4) opposite to the human body, are 1-10 mm circular holes (as shown in FIG. 3) or narrow long stripe-shape holes (gaps). In the preferred embodiment of the present invention, except the surface having pores (6) on the container (4), other surfaces also have pores (6). Compared with existing dosage forms of drugs, the present invention is hung or fastened by the connector (5). The connector (5) is a hanging or fixing object which is capable of using a fulcrum to hangingly support the drugs. These hanging or fixing objects are rope, belt, bag, rack, listing, box, hook or paste. While using, it can be hung by a small hanging object, such as a small listing, also can be hangingly fastened by the big shelf, such as a landing shelf. FIG. 3 shows the drug suspension agent using a rope connecting with the container (4) as the connector (5).

A method for manufacturing a drug suspension agent of the present invention comprises the steps of: \textcircled{1} synergizing by taking a drug, two drugs or more than two drugs; \textcircled{2} adding a supplementary material with a weight of 1-10% drug weight into the synergized drug, wherein the supplementary material is superfine tourmaline powder or ultrafine titanium dioxide powder commercially available with a particle size of 100 nm-10 μm, wherein the supplementary material can produce better effects, the effect of adding the supplementary material is better than that without the supplementary material; \textcircled{3} mechanically mixing the added synergized drug in a mixing machine under normal pressure to obtain a contents (2), wherein a mixing temperature is 15-25° C., preferably, 20° C., and a mixing time is 30-60 min, preferably, 45 min; \textcircled{4} packing dividually the mixed contents (2) with a microporous carrier material layer (3) into a plurality of packets based on 1-50 g different specification weights, namely, pack the mixed raw material in a powder filling machine, generally, the microporous carrier material layer is made into a reel shape, the powder filling machine automatically weighs, and then transmits the raw material to a packing valve, pack the raw material with the microporous carrier material layer (3), and then seal the microporous carrier material layer (3) by hot-melting to obtain a plurality of drug holders (1). Every drug holder (1) has different weights from 1 g to 50 g. The weight specification of every packet is determined by 1-500 times larger than clinical maximum daily dosage doses approved by pharmacopoeia or the national standard based on packed drug varieties, preferably, 50-100 times. For example, for drug Sibutramine, the pharmacopoeia prescribes the maximum daily administration dosage is 30 mg. Accordingly, in the present invention, the weight of every packet is determined as below: 30 mg×50=1500 mg, if the supplementary material is added by the weight of 10%, and then the weight of every packet is 1.65 g. Because drugs of the present invention will not enter the human or animal body, the dosage is large, and can be larger than 100 times (here, the weight of every packet can be larger than 50 g). However, this will result in the drug waste. The method further comprises the step of putting the packed drug holders (1) into a container (4), and \textcircled{6} installing a connector (5) to the container (4), thus obtaining the drug suspension agent.

The most important characteristics of the present invention is that the drug suspension agent with a new dosage form is retained at a non-contact hanging state with the human or animal skin and hung or fastened at 0.1-30 cm away from the surface skin. That is to say, the drug takes effect at 0.1-30 cm hanging away from the surface skin of the human or object. The minimum value of hanging distance is to retain the drug not contact the skin or mucous membrane. If the drug contacts the skin and mucous membrane, it will not be the new dosage form of the present invention. The furthest distance is 30 cm, if the distance is larger than 30 cm, the effect can not achieve the desired effect. The preferable distance is 1-3 cm, and can achieve the desired effect. The near distance hanging application of the present invention is a particular application of a dosage form of drugs, and different from the other dosage forms of drugs. At the same time, no drug substance enters the human body, the drug substance has no consumption, no qualitative change, no metabolism through the human or animal body, thus the drug substances hung in vitro remain original, the drug takes an effect by drug information superconducting to effectively cure, prevent the human and animal body diseases, or adjust physiological functions. Therefore, the present invention is different from other dosage forms of drugs.

The present invention is a new dosage form of drugs, and it uses different drugs to manufacture corresponding drug suspension agents which have the same clinical purposes with the drug holder (1). For example, for a drug suspension agent manufactured by Ofloxacin drug, Ofloxacin is clinically applied for acute and chronic infection of respiratory tract, throat, tonsil, urinary tract (including prostate), skin and soft tissues, gallbladder and bile duct, middle ear, sinus, intestine and other parts caused by Gram-negative bacteria, so clinical applications of the drug suspension agent manufactured by Ofloxacin are the same. Again, for a drug suspension agent manufactured by Acetaminophen, Acetaminophen has antipyretic and analgesic effects for fever, joint pain, neuralgia, migraine, and postoperative pain. Accordingly, clinical applications of the drug suspension agent manufactured by Acetaminophen are the same.

Following examples facilitate understand the present invention, but are not the limit of the present invention.

### Example 1

Take the active pharmaceutical ingredient comprising Sibutramine and L-carnitine, accessory tourmaline powder (with a particle size of 0.2 μm), mix these ingredients in proportion of 4:5:1 to put into the mixing machine, mix at 15° C.-25° C., and then put into the powder filling machine, pack into packets with the 0.5-1 μm microporous carrier non-woven material, wherein net weight of every packet is 5 g, put the packed packet into a multiporous square box made of ABS material to envelop, tie a strap, thus forming a drug suspension agent for treating obesity (abbreviated to OHD).

Supplies of the animal experiment for obesity are the same as those of the human body. However, the net weight of every packet is 0.5 g.

Clinical observations of the lipid-lowering effect of the above product on rat obesity and the obesity of human are shown as below.

A. Observing Lipid-Lowering Effect of OHD on Obese Rats

1. Material: OHD is provided by the inventor, nutritional drink formula is adding 10 g milk powder, 10 g lard, an egg and 7 g white sugar to 100 g basic diet. Experimental animals, provided by the experimental animal center, are clean SD male rats with the weight of about 50 g after weaning. Apparatus are BT-224 semi-automatic biochemical analyzer and DJ500 electronic precision balance. Data processing uses SYSTAT statistical software package to have an analysis of variance and Q test.

2. Experimental Methods

2.1 Establishing Nutritional Obesity Animal Model

Animals are randomly divided into six groups, wherein one group is the basic group fed with the basic diet, and the other five groups, fed with high fat diet, are the nutritional obesity model group. During feeding, the animals are free access to water and food. Every day, diet is fed twice. After 45 days, 17 animals are killed for determining fat weight in vivo and the ratio of fat to body weight, wherein 10 animals are from the basic group, and 7 animals are from the high lipid group.

2.2 Weight Test

Obesity model animals are randomly divided into the control groups according to body weight. OHD is hung on the rat body and 1 cm away from the rat body, once every day and four hours every time for 4 weeks. Animals are weighed once every week, and water and food are taken away at six hours before weighing. During the experiment, animals eat basic diet, freely eat food and drink water. While finishing the experiment, animals are fasted for 12 hours, and then decapitated for taking blood so as to measure the blood lipid, and then anatomized. Observe viscera of animals, take liver, left testis and fat pad around kidney to weigh, and count the ratio of the weight of fat to the weight of body, and the ratio of liver weight to body weight.

2.3 Determination of Biochemical Index

Total cholesterol (TC) is determined by CHOD-PAP method, high density lipoprotein cholesterol (HDL-C) is determined by enzyme-linked method, triglyceride(TG) is determined by Glycerol phosphate oxidase method. LDL-C is calculated by Friedewalk formula of LDL-C=TC−(TG/5+HDL-C); AI=(TC−HDL-C)/HDL-C.

3. Results

3.1 Establishing Nutritional Obesity Animal Model

After feeding for 45 days, 10 animals of the basic group and 7 animals of the high lipid group are taken out, and then these animals are beheaded for weighing body fat thereof. The results are shown in Table 1. The weight of testis and fat pad around kidney of the high lipid group is obviously higher than that of the basic group (P<0.05), and the ratios of fat to weight of the two parts are higher that that of the basic group. It is showed that feeding rats with high fat diet promotes the accumulation of body fat, thus resulting in obesity.

TABLE 1
Compare the body fat weight of rats of the basic group (n = 10) with that
of the high lipid group (n = 7) (x ± s)

| Classification | W(g) | F₂ (g) | F₂ (mg)/W(g) | F₁ (g) | F₁ (mg)/W(g) |
|---|---|---|---|---|---|
| Basic Group | 252.3 ± 10.6 | 0.26 ± 0.13 | 1.030 ± 0.490 | 0.843 ± 0.123 | 3.340 ± 0.468 |
| High Fat | 243.0 ± 11.7 | 0.58 ± 0.16 | 2.366 ± 0.642 | 1.121 ± 0.124 | 4.605 ± 0.387 |
| Group | | | | | |

Note:
W is the weight at 45 days after animal fattening, F2 is the weight of the fat pad around the left kidney, F1 is the weight of the fat pad around the left testis

3.2 Effects of OHD on the Weight Value-Added of Rats of Every Group

After obesity animals use OHD for 4 weeks, the weekly weight values-added of animals of every group are different, compared with the negative control group, the differences are significant (P<0.01), results are shown in Table 2. The weight value-added of animals of the test group after one week is smaller than that of the negative control group, and that of the two groups are significant (P<0.01).

TABLE 2
Compare the weight values-added of rats of various groups (x ± s) (g)

| | The number | Before experiment | One | Two | Three | Four |
|---|---|---|---|---|---|---|
| Classification | of animals | (weight) | week | weeks | weeks | weeks |
| Control Group | 15 | 288.61 ± 15.37 | 30.47 ± 7.57 | 41.02 ± 7.76 | 52.53 ± 7.84 | 53.59 ± 13.85 |
| OHD Group | 10 | 289.33 ± 14.20 | 4.28 ± 12.12 | 11.97 ± 10.22 | 28.27 ± 13.19 | 18.27 ± 12.52 |

3.3 Effects of OHD on Body Fat in Rats, Liver, the Ratio of Fat Weight to Body Weight and the Ratio of Liver Weight to Body Weight

After obesity animals use OHD for 4 weeks, the effects on body fat in rats, liver and so on are shown in Table 3. It is found that the weight of fat pad around the rat testis, the weight of liver of the OHD group are smaller than that of the negative control group, respectively, the differences are significant (P<0.05). The weight of fat pad around the kidney, two ratios of fat weight to body weight, the weight of liver and the ratio of liver weight to body weight of the OHD group are smaller than that of the negative control group.

TABLE 3
Compare the fat weight of organs and organ coefficient of rats of every group (x ± s) (g)

| | The number | | | The weight | F₁ | F₂ | |
|---|---|---|---|---|---|---|---|
| | of animals | F₁ | F₂ | of liver (L) | (mg)/W(g) | (mg)/W(g) | L/W |
| Control group | 15 | 2.243 ± 0.484 | 1.004 ± 0.355 | 10.420 ± 1.130 | 6.513 ± 1.035 | 2.892 ± 0.832 | 0.030 ± 0.002 |
| OHD group | 10 | 1.813 ± 0.390 | 0.790 ± 0.262 | 8.681 ± 0.079 | 5.858 ± 1.028 | 2.534 ± 0.730 | 0.028 ± 0.001 |

Note:
W is the weight of animals after experiment, F2 is the weight of the fat pad around the left kidney, F1 is the weight of the fat pad around the left testis

3.4 Effects of OHD on the Lipid Level of Rats

After obesity animals use OHD by gavage for 4 weeks, lipid test results show that: TC and TG of animal serum of the test group is close to that of the negative control group, other indexes are shown in Table 4. It is found that compared with the negative control group, animal high-density lipoprotein-cholesterol of the test group is obviously higher than that of the negative control group, and the difference is significant (P<0.01), LDL-C and AI have the decreasing trend, and HD L-C/TC and HD L-C/LD L-C have increasing trend.

TABLE 4
Effects of OHD on the lipid level of rats (x ± s) (g)

| | The number | HDL-C | LDL-C | HDL-C/ | HDL-C/ | |
|---|---|---|---|---|---|---|
| Classification | of animals | (mmol/L) | (mmol/L) | TC | LDL-C | AI |
| Control group | 15 | 1.234 ± 0.119 | 0.648 ± 0.166 | 0.628 ± 0.065 | 2.118 ± 0.985 | 0.607 ± 0.154 |
| OHD group | 10 | 1.440 ± 0.074 | 0.618 ± 0.137 | 0.671 ± 0.047 | 2.440 ± 0.589 | 0.498 ± 0.104 |

3.5 Observation of Behavior and Organ of Animals

During experiment, animals' eating food and drinking water are normal. Compare the test group with the control group, the difference of eating food is not significant, and feces have no abnormalities. While finishing the experiment, animals are beheaded to check various organs. It is found that animal liver, kidney, spleen and heart are normal, and liver is bright red and smooth.

B. Observation of Curative Effect of OHD on Human Obesity

1. Clinical Data

1.1 Research Object

In generally, obesity is that the body weight is 20% larger than the standard body weight. Adult standard body weight (kg)=(the height expressed by centimeter−100)×0.9, children standard body weight (kg)=the age×2+8, obesity degree (%)=(existing body weight−standard body weight)/the standard body weight×100%, serious obesity body weight≧50% of standard body weight, diabetes obesity is body weight≧50% of standard body weight and has type II diabetes. Based on the above standard, select 90 cases of obesity, male are 50 cases, female are 40 cases.

1.2 Grouping

According to body weight, age, concomitant diseases and administration method, 90 patients are randomly divided into 5 groups. Serious obesity group (A group) comprises 20 cases, adult obesity group (B group) comprises 18 cases, minor obesity group (C group) comprises 30 cases, diabetes obesity group (D group) comprises 20 cases, and rapid loss weight group (E group) comprises 12 cases.

2. Treatment Method

2.1 General Loss Weight Method

During the course of treatment, OHD is hung close to the skin on the breast within the clothes at morning every day, and 0.5-1 cm away from the skin. After using for 4 fours, OHD is taken down at afternoon, once every day. Then, according to individual demands, eat proper rice and green vegetables mixed in cool and stir-fried, also can eat a few high protein low fat food. At 30 min after meal, eat 300 ml plain boiled water. A course of treatment of obesity is 30 days, and that of serious obesity and diabetes obesity are 60 days.

2.2 Rapid Loss Weight Method

During the course of treatment, OHD is hung on the breast within the clothes every day, and 0.5-1 cm away from the skin for 8 hours. OHD is taken down at evening, once every day. A course of treatment is 30 days. At 30 min after meal, eat 300 ml plain boiled water, integrated with controlling diet and physical exercises.

2.3 Notes

During the course of loss weight, no other weight loss products are needed. Patients with diabetes still administer original hypoglycemic drugs. Patients with high blood pressure still administer original antihypertensive drugs.

3. Observation of Curative Effect

3.1 Observing Indexes

(1) Test the height, fasting weight and abdominal circumference before and after curing.

(2) Test blood glucose, blood cholesterol, triglycerides and high density lipoprotein before and after curing.

(3) Observe whether there is anorexia, fatigue, diarrhea, dizziness or other adverse reactions or not.

3.2 Changes of Body Weight and Abdominal Circumference as Shown in Table 5

TABLE 5
Changes of body weight and abdominal circumference of every group
after curing (x ± s)

| | Body weight (kg) | Abdominal circumference (cm) |
|---|---|---|
| Classification | Decrease per capita | Reduce per capita |
| A group | 7.80 ± 0.89 | 10.18 ± 1.60 |
| B group | 4.66 ± 1.15 | 4.48 ± 1.78 |
| C group | 3.68 ± 1.23 | 4.86 ± 2.35 |
| D group | 3.76 ± 0.65 | 8.04 ± 1.51 |
| E group | 3.66 ± 0.97 | 9.11 ± 1.85 |
| Total | 4.48 ± 1.13 | 5.80 ± 2.20 |

It is found from Table 5 that body weight of the serious obesity group (A group) is decreased per capita 7.80±0.89 kg, and abdominal circumference is reduced per capita 10.18±1.60 cm, the effect is the most significant. After curing, body weight of every group is obviously decreased, abdominal circumference is obviously reduced, the differences are significant (P<0.01).

3.3 Changes of Blood Glucose and Lipid

OHD has a certain improvement effect on blood glucose and lipid.

### Example 2

Take the active pharmaceutical ingredient comprising Omeprazole, Clarithromycin, Bismuth citrate, extract of Ligustrum lucidum Ait, accessory tourmaline powder (with a particle size of 0.2 μm), mix these ingredients in proportion of 2:2:2:3:1 to put into the mixing machine, generally mix at 15° C.-25° C., and then put the mixture into the powder filling machine, pack the mixture into packets with the 0.5-1 μm microporous carrier non-woven material, wherein net weight of every packet is 5 g, put the packet into a multiporous box made of ABS material and envelop, tie a strap, thus forming a drug suspension agent for treating ulcer disease (abbreviated to NHD).

Clinical observations of the effect of the above product on gastric and duodenal ulcer patients are shown as below.

Clinical observations of the effect of NHD on gastric and duodenal ulcer patients are shown as below.

1. Case selection: Selected 80 inpatients are in accordance with gastric and duodenal ulcer diagnostic criteria. The inpatients are randomly divided into two groups. The treatment group has 50 inpatients which consist of 35 male inpatients and 15 female inpatients, the age is in the range of 24 to 62 years old, the average is (35.5±11.3) years old; the course of disease is 0.5-20 years, the average is (6.4±2.8) years; 19 inpatients have a gastric ulcer, 26 inpatients have a duodenal ulcer, 5 inpatients have a compound ulcer; results of fecal occult blood test of 44 inpatients are negative, that of 4 inpatients are weak-positive, that of 2 inpatients are positive. The control group has 30 inpatients which consist of 18 male inpatients and 12 female inpatients, the age is in the range of 20 to 68 years old, the average is (34.4±12.4) years old; the course of disease is from 4 months to 18 years, the average is (6.5±3.0) years; 10 inpatients have a gastric ulcer, 13 inpatients have a duodenal ulcer, 7 inpatients have a compound ulcer; results of fecal occult blood test of 25 inpatients are negative, that of 3 inpatients are weak-positive, that of 2 inpatients are positive. The difference between two groups treated by X² statistics has no significant meaning (P>0.05), so the two groups are comparable.

2. Method of treatment: NHD is hung within clothes at patients' chest, 0.5-1 cm away from the skin at morning every day for 5 hours, and taken down at afternoon, once every day. The course of treatment is one month. After two months, review by gastroscopy. Omeprazole is used in the control group by oral administration once every day, one piece every time (20 mg), the course of treatment is the same.

3. Observation items: ulcer surface (regarding results tested by gastroscope as standard), partial clinical symptoms (such as abdominal pain and acid reflux)

4. Curative effect evaluation standard: referring to Chinese national diagnostic curative effect standard. Clinical treatment is the ulcer surface tested by gastroscope is healed, and clinical symptoms disappear or basically disappear; marked effect is the ulcer surface tested by gastroscope is obviously reduced or enter the scar period, clinical symptoms basically disappear or are obviously reduced; turning better is the ulcer surface tested by gastroscope is not obviously reduced, however, gastric mucosal congestion and edema turn better, and clinical symptoms are reduced; invalid effect is no changes exist before and after curing (the ulcer surface tested by gastroscope has no changes, and clinical symptoms have no improvement.

5. Results are shown in Tables 1 and 2

TABLE 1
Contrast of curative effects of two groups

| | | | | | | Total |
|---|---|---|---|---|---|---|
| | The number | | Marked | Turning | Invalid | efficient |
| Group | of cases | Healing | effect | better | effect | rate (%) |
| Treat | 50 | 14 | 11 | 21 | 4 | 92.0 ¹⁾ |
| group | | | | | | |
| Control | 30 | 6 | 6 | 13 | 5 | 83.3 |
| group | | | | | | |

TABLE 2
Contrast of needed time for curing diseases of two groups

The course
of treatment

| Group | The number of cases | 6 | 7 | 8 | 9 |
|---|---|---|---|---|---|
| Treat Group | 14 | 2 | 5 | 5 | 2 |
| Control Group | 6 | 0 | 0 | 2 | 4 |

### Example 3

Take the active pharmaceutical ingredient comprising Sildenafil, Tadalafil, Icariin (95% content), accessory ultrafine titanium dioxide powder (with the particle size of 0.1 μm), mix these ingredients in proportion of 3:3:3:1 to put into the mixing machine, generally mix at 15° C.-15° C., and then put the mixture into the powder filling machine, pack the mixture into packets by the 0.5-1 μm microporous carrier non-woven material, wherein net weight of every package is 3 g, put the packet into a multiporous square box made of ABS material and envelop, tie a strap, thus forming a drug suspension agent for treating male sexual dysfunction (abbreviated to EDHD).

Clinical observations of the effects of the above product on sexual dysfunction patients are shown as below.

Clinical observations of the effect of NHD on sexual dysfunction patients are shown as below.

1. Case selection: Select 56 sexual dysfunction and voluntary subjects as test objects, and use the international evaluation questionnaire to have a placebo contrast, dual blind clinical trial preparation. The average age of test objects is 39±6.1 years old, the average of the course of disease is 5.4±3.7 years.

The packaging of experimental product EDHD is the same as that of placebo. Testers and tested objects don't know test conditions of the product information to test. Selected volunteers are randomly divided into two groups, and use placebo or experimental product once every two days, 3 hours every time for 1 month. Patients complete the sexual function questionnaires (five pages, score every item with 5 degree). Compare changes of the sexual function before and after using to analyze and evaluate curative effects.

Results: Before curing, evaluation scores of tested people are shown as below. The score of self-confidence sense to erection and maintaining function of erection is 1.82±0.54. The score of the erection frequency of penis inserting into vagina is 1.89±0.67. The score of the difficulty of penis erection and erection maintaining during sexual intercourse is 1.89±0.61. The score of the satisfaction to sexual lives is 1.79±0.62. After curing, evaluation scores of sexual function are shown as below. The score of self-confidence sense to erection and maintaining function of erection in the EDHD group is 3.32±0.39, and that in the placebo group is 2.04±0.63. The score of the erection frequency of penis inserting into vagina in the EDHD group is 3.11±0.32, and that in the placebo group is 2.07±0.88. The score of the frequency of penis inserting into vagina and erection maintaining during sexual intercourse in the EDHD group is 3.18±0.4, and that in the placebo group is 2.17±0.97. The score of the difficulty of penis erection and erection maintaining during sexual intercourse in the EDHD group is 3.25±0.43, and that in the placebo group is 2.18±0.92. The score of the satisfaction to sexual lives is in the EDHD group is 3.36±0.47, and that in the placebo group is 2.14±0.95. The score of the EDHD group is significantly higher than that of the placebo group (P<0.01). Total clinical effects of the EDHD group and the placebo group are 75.4% and 35.4%, respectively. No obvious side effects are found. Results are shown in following Table 1.

TABLE 1
IIEF score sheet of curative effects of EDHD product on sexual
dysfunction

| | Self-confidence | | | |
|---|---|---|---|---|
| | sense to erection | | Erection frequency | |
| | and maintaining | | of penis inserting | |
| | function of erection | | into vagina | |
| | Before | After | Before | After |
| | treating | treating | treating | treating |
| EDHD product | 1.82 ± 0.54 | 3.32 ± 0.39 | 1.89 ± 0.67 | 3.11 ± 0.32 |
| (n = 28) | | | | |
| Placebo | | 2.04 ± 0.63 | | 2.07 ± 0.88 |
| (n = 28) | | | | |
| P value | | 0.002 | | 0.001 |
| | Frequency of | | | |
| | penis erection | | | |
| | during sexual | | | |
| | intercourse and | | | |
| | erection maintaining | | Difficulty of penis | |
| | retains to | | erection and | |
| | sexual intercourse | | erection maintaining | |
| | Before | After | Before | After |
| | treating | treating | treating | treating |
| EDHD product | 1.82 ± 0.65 | 3.18 ± 0.47 | 1.89 ± 0.61 | 3.25 ± 0.47 |
| (n = 28) | | | | |
| Placebo | | 2.17 ± 0.97 | | 2.18 ± 0.92 |
| (n = 28) | | | | |
| P value | | 0.001 | | 0.002 |

Satisfaction to
sexual lives

| | Before treating | After treating |
|---|---|---|
| EDHD product | 1.79 ± 0.62 | 3.36 ± 0.47 |
| (n = 28) | | |
| Placebo (n = 28) | | 2.14 ± 0.95 |
| P value | | 0.001 |

### Example 4

Take the active pharmaceutical ingredient comprising Gliquidone, Metformin, Balsam pear extract, accessory ultrafine Titanium dioxide powder (with the particle size of 0.1 μm), mix these ingredients in proportion of 2:3:4:1 to put into the mixing machine, generally mix at 15° C.-25° C., and then put the mixture into the powder filling machine, pack the mixture into packets with the microporous carrier non-woven material with the pore diameter of 0.5-1 μm, wherein net weight of every packet is 5 g, put the packet into a multiporous square box made of ABS material and envelop, tie a strap, thus forming a drug suspension agent for treating diabetes (abbreviated to DHD).

Observation data about clinical curative effect of the above mentioned product on diabetes are shown as below.

Observation Data about Clinical Curative Effect of DHD on Diabetes

1. The standard of selecting patients: All patients with diabetes are in accordance with WHO diabetes diagnostic criteria. Select 18 cases of urine protein, renal function and two groups with the matching developing speeds of renal function injury within one year from diabetes kidney disease patients (DN). The two patients are respectively male in half, female in half, the age, the course of diabetes disease, urine protein, urea nitrogen (BUN) and glycated hemoglobin (HBA1c) have not obvious significant differences (P>0.05) by statistical test, as shown in Table 1.

TABLE 1
Conditions of patients

| | The number | | Course of | Urine protein | BUN | HbAlc |
|---|---|---|---|---|---|---|
| Group | of cases | Age | diabetes | (g/L) | (mmol/L) | (%) |
| Control group | 8 | 54 ± 6.7 | 10.3 ± 7.1 | 6.2 ± 2.5 | 9.5 ± 0.7 | 6.5 ± 1.2 |
| Treatment group | 10 | 57 ± 6.6 | 12.4 ± 5.9 | 6.9 ± 2.8 | 9.2 ± 0.3 | 6.4 ± 1.3 |

2. Therapeutic Method

Once patients are selected, other drugs related to sugar, fat metabolism are stopped administering, diet control and proper exercise therapy are continued. Test fasting blood glucose and blood glucose at 2 hours after the meal every week. After stabilizing the blood glucose, experimental treatment is performed, the treatment group uses DHD, once every day, four hours every time. The control group is independently administered Gliquidone, once every day, 30 mg every time, and gradually increased to 90 mg. The two groups are continuously administered for 12 weeks, and fasting blood glucose, blood glucose at 2 hours after the meal, urine protein, urea nitrogen (BUN) and plasma creatinine (Scr) are tested, and simultaneously adverse drug reactions are recorded at the 2^{nd} week, 4^{th} week, 8^{th} week and 12^{th} week before and after treatment.

3. Results: By statistic treatment, clinical curative effects between the two groups are tested by Ridit, and observation indexes between the two groups and within every group before and after treatment are tested by t-test.

3.1 Curative Effect Standard is Based on China Formulated by the State Glucose-Lowering Drug Efficacy Evaluation Standards

Marked: Fasting blood glucose (FBG)≦7.2 mmol/L or reduced≧30%, blood glucose at two hours after the meal (PBG)≦8.3 mmol/L or reduced≧30%

Effective: FBG is reduced to 7.3-8.3 mmol/L or reduced 10%-29%, PBG is reduced to 8.4-10.0 mmol/L or reduced 10%-29%

Invalid: FBG has no change or is reduced no less than 10%, PBG has no change or is reduced no less than 10%

Observation methods for Nephropathy curative effect and improvement of the liver and kidney: compare damage indexes, such as urine protein, urea nitrogen (BUN) and plasma creatinine (Scr) whether they have significant differences before and after administration or not.

3.2 Clinical Curative Effects (as Shown in Table 2)

TABLE 2
Contrast of clinical curative effects between the two groups

| | | | | | Total |
|---|---|---|---|---|---|
| | The number | | | | efficient |
| Group | of cases | Marked | Effective | Invalid | rate |
| | | Fasting blood glucose (FBG) | | | |
| Control group | 10 | 3 | 6 | 1 | 90.0 |
| Treatment group | 12 | 5 | 7 | 0 | 100.0 |
| | | Blood glucose at | | | |
| | | 2 hours after the meal | | | |
| Control group | 10 | 4 | 6 | 0 | 100.0 |
| Treatment group | 12 | 7 | 5 | 0 | 100.0 |

3.3 Blood Sugar Changes at Fasting and Two Hours after the Meal Before and after Treatment of the Two Groups (as Shown in Table 3)

TABLE 3
Blood sugar changes at fasting and two hours after the meal before and
after treatment of the two groups

| | Before | After treating | | | |
|---|---|---|---|---|---|
| Group | treating | 2 weeks | 4 weeks | 8 weeks | 12 weeks |
| | Fasting blood glucose (FBG) | | | | |
| Control group | 10.72 | 9.99 | 9.27 | 8.43 | 7.62 |
| Treatment group | 10.68 | 9.76 | 9.05 | 8.12 | 6.26 |
| | Blood glucose at 2 hours after the meal | | | | |
| Control group | 14.79 | 17.48 | 12.77 | 10.07 | 9.21 |
| Treatment group | 14.88 | 13.24 | 12.35 | 9.57 | 7.66* |

*means significant difference (P > 0.05)

3.4 Blood Fat Examination Results of the Two Groups Before and after Treatment, as Shown in Table 4

TABLE 4
Blood fat examination results of the two groups before and after
treatment

| | The | | | | |
|---|---|---|---|---|---|
| | number | | | | |
| | of | | | BUN | |
| Group | cases | | Urine protein | (mmol/L) | Scr (μmol/L) |
| Control | 8 | Before | 6.2 ± 2.5 | 9.5 ± 0.7 | 251.3 ± 54.6 |
| group | | treating | | | |
| | | After | 6.0 ± 2.7 | 9.2 ± 0.6 | 250.9 ± 49.3 |
| | | treating | | | |
| Treat- | 10 | Before | 6.9 ± 2.8 | 9.2 ± 0.3 | 248.2 ± 56.1 |
| ment | | treating | | | |
| group | | After | 5.8 ± 2.1* | 7.3 ± 0.5* | 153.4 ± 47.5* |
| | | treating | | | |

*means significant differences (P > 0.05)

### Example 5

Take the active pharmaceutical ingredient comprising Finasteride, icariin, tanshinone, accessory ultrafine tourmaline powder (with the particle size of 0.2 μm), mix these ingredients in proportion of 2:3:4:1 to put into the mixing machine, generally mix at 15° C.-25° C., and then put the mixture into the powder filling machine, pack the mixture into packets by the microporous carrier non-woven material with the pore diameter of 0.50-1 μm, wherein net weight of every package is 3 g, put the packet into a multiporous square box made of ABS material and envelop, tie a strap, thus forming a drug suspension agent for treating prostate disease (abbreviated to PHD).

Observation data of clinical curative effects of the above mentioned product on male Prostatic hyperplasia are shown as below.

Observation Data of Clinical Curative Effects of PHD on Male Prostatic Hyperplasia

1. Observed Objects and Methods

Case selection: 72 patients, male, wherein 53 cases with the age of 60-69 years old, 16 cases with the age of 70-79 years old, 3 cases with the age of 80-89 years old. The longest course of disease is 11 years, the shortest is 3 months. There are 6 cases with the course of disease smaller than one year, 48 cases with the course of disease in the range of 1-4 years, 14 cases with the course of disease in the range of 5-10 years, 4 cases with the course of disease bigger than 10 years. There are 12 cases with prostate enlargement I-degree, 44 cases with prostate enlargement II-degree, and 16 cases with prostate enlargement III-degree. There are 4 cases integrated with bladder stones, and 6 cases with urinary infection.

Observation method: based on the ages of patients, course of disease and state of illness, patients are divided into two groups.

(1) The control group comprises 36 patients, administered with finasteride tablet, one every time, one time every day, oral administration.

(2) The treatment group comprises 36 patients, administered with PHD, four hours every time, one time every day, hanging.

Observe patients' symptoms before and after administration which mainly includes frequent urination at night, difficult urinating, urination becoming thinner, drop after urination, micturition pain, and urgent urination. No, light, medium, heavy symptoms are scored 0, 1, 2, 3 respectively. Observe integral changes before and after treatment. Rectal touch and B ultra examination are made to observe the recovery condition of prostate enlargement.

2. Therapeutic Evaluation

Based on the ratio of the integral difference of local symptom before administration to that after administration and the condition of prostate recovery, curative effects are evaluated. If healing, the integral ratio is 1, and prostate enlargement is back to normal. If marked, the integral ratio is larger than and equal to 2/3, and prostate enlargement is significantly improved. If effective, the integral ratio is in the range of 2/3 to 1/3, and prostate enlargement is improved. If invalid, the integral ration is smaller than 1/3, and prostate enlargement has no change.

3. Results and Analysis

(1) Integral values of local symptoms of the control group before and after administration have significant differences (P>0.05), however, the treatment group has significant changes (P<0.001). Integral values of local symptoms of the two groups have significant changes (P<0.05), integral values of local symptoms of the treatment is lower than that of the control group.

(2) In 36 cases of control group, there are 4 healing cases, 10 marked cases, 6 effective cases and 16 invalid cases, wherein there are 26 total effective cases (52.78%), however, in 36 cases of treatment group, there are 9 healing cases, 15 marked cases, 6 effective cases and 6 invalid cases, wherein there are 30 total effective cases (88.33%). The clinical effects of the two groups have significant differences (P<0.01), the clinical effect of the treatment is better than that of the control group.

Table Showing Clinical Observation Results of Prostatic Hyperplasia Before PHD Treatment

| | The number | | | Effec- | In- | Total |
|---|---|---|---|---|---|---|
| Group | of cases | Healing | Marked | tive | valid | efficient rate |
| Control | 36 | 4 | 10 | 6 | 16 | 52.78% |
| group | | | | | | |
| Treat- | 36 | 9 | 15 | 6 | 6 | 88.33% |
| ment | | | | | | |
| group | | | | | | |

### Example 6

Take the active pharmaceutical ingredient amlodipine powder whose production date is within one year, put the powder into the powder filling machine, pack the powder into packets by the microporous carrier non-woven material with the pore diameter of 0.5-1 um at 15° C.-25° C., wherein net weight of every package is 10 g, put the packet into a porous round box made of ABS material and envelop, tie a strap, thus forming a drug suspension agent for treating high blood pressure.

The present invention is adapted for treating elder people primary hypertension high blood pressure, clinical effects are observed as below.

68 cases of essential hypertension from outpatients or older cadre inpatients comprises 48 male cases, 20 female cases, the age is 63-81 years old, the average is 68±6.4 years old. According to WHO Diagnostic criteria, 41 cases of I-period high blood pressure, 15 cases of II-period high blood pressure, and 12 cases of III-period high blood pressure. All medicine, which can affect blood pressure, are stopped using for a week before treatment.

The present invention is used to treat diseases. Method of use: hang the product of the present invention at the umbilical part of the human body, a surface with pores of the box faces to the umbilical skin and is about 0.5-1 cm away from the umbilical skin. Every hanging remains 3 hours, once every day, the treatment cycle is 8 weeks. Blood pressure is tested once at morning and evening of every day during treatment respectively. Before and after taking medicine, EKG, heart B-ultrasonography, blood glucose (GLU), glutamic-pyruvic transaminase (TG), high-density lipoprotein (HDL) and other indexes are tested. Statistic method: data adopts x±s, measurement adopts t test, count adopts x² test.

Results: By curative observation for continuous 8 weeks, it is shown that arterial blood pressure is decreased significantly after treatment, and the value of blood pressure measurement is not obviously fluctuated (as shown in Table 1). Compare blood biochemical indicators before treatment with that after treatment, no significant abnormality exists (as shown in Table 2). By EKG routine examination before treatment, it is shown that 16 cases of left ventricular hypertrophy, 14 cases of Left ventricular high voltage, 18 cases of ST-T Ischemic change, 11 cases of sporadic ventricular premature beat, 2 cases of ventricular premature beat bigeminy, 16 cases of left ventricular wall thickening, 8 cases of abnormal ventricular wall activity. By EKG reexamination after treatment, it is shown that ST-T is improved, 4 cases of ventricular premature beat disappear, and heart B-ultrasonography has no change. No adverse reaction exists during the treatment course.

TABLE 1
Contrast of the blood pressure of 68 older patients
with high blood pressure before and after curing

| | I period | | II period | | III period | |
|---|---|---|---|---|---|---|
| | SBP | DBP | SBP | DBP | SBP | DBP |
| Before treating | 19.8 ± 3.1 | 12.5 ± 1.2 | 20.5 = 3.7 | 12.8 ± 1.1 | 21.6 ± 3.9 | 13.8 ± 1.5 |
| After treating | 17.1 ± 1.5 | 10.2 ± 0.9 | 17.7 = 1.8 | 10.7 ± 0.8 | 11.8 ± 1.7 | 11.5 ± 1.6 |
| P | <0.05 | <0.05 | <0.05 | <0.05 | <0.05 | <0.05 |

TABLE 2
Contrast of blood indexes of 68 older patients with
high blood pressure before and after curing

| | AST | GLU | BUN | TC | TC | HDL |
|---|---|---|---|---|---|---|
| | (IU/L) | (mmol/L) | (mmol/L) | (mmol/L) | (mmol/L) | (mmol/L) |
| Before treating | 12 ± 0.5 | 5.2 ± 0.9 | 5.1 = 5.1 | 5.8 ± 1.7 | 1.67 ± 0.8 | 1.3 ± 0.5 |
| After treating | 13 ± 0.3 | 5.1 ± 0.8 | 5.7 = 1.4 | 5.5 ± 1.9 | 1.1 ± 0.8 | 1.2 ± 0.5 |
| P | >0.05 | >0.05 | >0.05 | >0.05 | >0.05 | >0.05 |

### Example 7

Take the active pharmaceutical ingredient 10-hydroxycamptothecine whose production date is within one year, smash at 15° C.-25° C. till the particle size is 10 μm, and then put into the powder filling machine, pack the powder into packets by the microporous carrier non-woven material with the pore size of 0.50 μm, wherein net weight of every package is 15 g, put into a porous round box made of ABS material and envelop, tie a strap, thus forming a hanging drug suspension agent for treating gastric cancer.

The present invention is adapted for treating advanced gastric cancer. Observation data of clinical curative effect are shown as below.

Ten cases of advanced gastric cancer, diagnosed by pathology, comprise 7 male cases and 3 female cases, the age is 60-72 years old, the average age is 66 years old. Pathological types: 5 cases of low differentiated adenocarcinoma, 3 cases of mucinous adenocarcinoma, and 2 cases of signet ring cell carcinoma.

Instead of radiotherapy and chemotherapy, the treatment is hanging the product of the present invention at the umbilical part of a curer, a surface with pores of the round box faces to the umbilical skin and is about 0.5 cm away from the umbilical skin, every hanging remains 4 hours, once every day, the treatment cycle is one month. The curative effect is evaluated after treatment for two cycles.

Curative effect evaluation: curative effect evaluation and side effect evaluation are in accordance with WHO solid tumor curative effect evaluation standard. \textcircled{1} Complete remission (CR) is all measurable lesions completely disappear for more than 4 weeks; Partial remission (PR) is that the product of two maximum vertical diameters of measurable lesions is reduced to be more than 50% for more than 4 weeks; Stabilization (SD) is that the product of two maximum vertical diameters of measurable lesions is reduced to be more than 25% and less than 50%, or stable remission is that original lesions are increased to be not more than 25% and no new lesion appears. Progress (PD) is that the product of two maximum vertical diameters of original lesions is increased to be more than 25%, or new lesions appear. Efficiency=CR+PR. \textcircled{2} Toxic reaction is I-IV degree, III-degree or IV-degree is regarded as the serious toxic reaction. \textcircled{3} The quality of life is evaluated at one month before and after treatment in accordance with KPS rating criteria. For example, significant improvement is that KPS score after treatment is 20 more than KPS score before treatment, improvement is that KPS score after treatment is 10 more than KPS score before treatment, stabilization is that KPS score after treatment is the same as KPS score before treatment, decrease is that KPS score after treatment is 10 less than KPS score before treatment, efficiency=significant improvement+improvement.

Clinical curative effect: 1 example of CR occupies 10%, 5 examples of PR occupy 50%, 2 examples of SD occupy 20%, 2 examples of PD occupy 20%, 6 examples of CR+PR occupy 60%.

Side-effect is only I-degree, no side-effect more than II-degree exists.

Improve the quality of life: after treatment, the qualities of life of six examples are significantly improved, that of one example is improved, that of two examples is stabilized, that of one example is reduced, and the total efficiency is 70%.

What is claimed is:

1. A drug suspension agent which is 0.1-30 cm away from surface skin of a human or animal body, comprising:
a container, a connector, and a drug holder;
wherein the drug holder comprises a microporous carrier material layer having a plurality of pores on a surface thereof opposite to the human body, and a content encased within said carrier material layer, wherein said content comprises a drug having pharmacological activities;
wherein the drug interacts with a human or animal receptor;
wherein the drug comprises a compound, a biological product, or a composition which acts on a human or animal to provide treatment or prevention of a human or animal disease, or to regulate a human or animal physiological function, or to promote conception or contraception;
wherein the drug holder is provided within said container;
wherein the connector is connected with said container;
wherein the drug suspension agent is configured to be used once daily, for a single period of 4 hours, or 5 hours or 8 hours;
wherein said carrier material layer, made of a microporous breathable material with a pore diameter of 50 nm-200 μm, is a microporous non-woven fabrics, microporous fiber cloth, microporous paper, microporous plastic, micropore ceramic, microporous metal or microporous forming material;
wherein the container is a rectangular, square, round, oblate, cylindrical, triangular, polygonal, or irregular shaped box or bag container;
wherein the container comprises pores on one side as well as another side;
wherein each of said pores is a circular pore with a diameter of 1-10 mm, a slot shaped pore or other shaped pores;
wherein the connector comprises a suspending piece or an immobilizing piece that supports the drug suspension agent by a supporting point; wherein the suspending piece or immobilizing piece is a rope, a cord, a string, a hanger, a rack, a case, a hook, or a stick;
wherein the drug suspension agent is manufactured by a method comprising the steps of:
(1) providing one or more pharmaceutical ingredients at a predetermined weight;
(2) adding a supplementary material with a weight of 1-10% of the predetermined weight;
(3) mechanically mixing the added pharmaceutical ingredient and supplementary material in a mixing machine under normal pressure, at a mixing temperature of 15-25° C., with a mixing time of 30-60 minutes;
(4) dividing the content in a packaging machine into individual packages with a weight of 1-50 gram per package; wherein said weight comprises 1-500 times of a clinical maximum daily dosage approved by a pharmacopoeia or national standard based on drug varieties;
(5) sealing the microporous carrier material layer through hot melt technology to form the drug holder;
(6) putting the drug holder into a container; and
(7) installing the connector on the container, thus obtaining the drug suspension agent;
wherein said supplementary material in step (2) is superfine tourmaline powder of titanium dioxide powder with a particle size of 100 nm-10 μm;
wherein during usage, the drug suspension agent is configured to be placed in suspension or immobilized to a surface skin of chest area, upper abdominal area, navel area, lower abdominal area, facial area, or back area of a human or animal, and the drug suspension agent is configured to be clinically effective in application as the one or more pharmaceutical ingredients contained therein.

2. A drug suspension agent of claim 1, which is 1-3 cm away from surface skin of a human or animal body, wherein the weight of each package is determined by the proportion of the clinical maximum daily dosage approved by a pharmacopoeia or national standard according to the drug varieties in the mix.
